(19) United States
(12) Patent Application Publication
(10) Pub. No.: US 2024/0044584 A1
(43) Pub. Date: Feb. 8, 2024

(54) Thermal Regulation Device

(71) Applicant: HUTCHINSON, PARIS (FR)

(72) Inventors: Loïc DE FRANCQUEVILLE, MONTIGNY SUR LOING (FR); Bertrand FLORENTZ, PAUCOURT (FR); Fabrice CHOPARD, SAINT MARTIN D'HERES (FR); Andrea CAPILLO, TURIN (IT); Axel BRIAND, SAINT PERE EN RETZ (FR); Philippe BOREL, BRUGES (FR); Sébastien PHILIPPE, SAINT JEAN D'ILLAC (FR)

(21) Appl. No.: 18/269,448

(22) PCT Filed: Dec. 17, 2021
(86) PCT No.: PCT/FR2021/052390

§ 371 Date: Jun. 23, 2023

(30) Foreign Application Priority Data
Dec. 23, 2020 (FR) FR2014072

(51) Int. Cl. F28D 20/00; H01M 10/6569; H01M 10/625

(52) U.S. Cl. CPC F28D 20/0034; H01M 10/6569; H01M 10/625; H01M 2220/20

(57) ABSTRACT

A thermal regulation device for a member to be heated or to be cooled includes a fluid-circulation conduit having at least one flexible part able to deform according to the pressure of the fluid within the conduit, and at least one contact zone coming into contact with said member when the pressure of the fluid in the conduit is higher than a given pressure and which is moved away from said member when the pressure of the fluid in the conduit is below the given pressure, the thermal regulation device including regulation means able to vary the pressure of the fluid in the conduit.

### TECHNICAL FIELD OF THE INVENTION

The invention relates to a thermal regulation device intended in particular for providing the cooling and/or the heating of a battery of an automobile.

### PRIOR ART

Automobiles, in particular electric or hybrid vehicles the propulsion of which is provided at least partially by an electric motor, are equipped with a battery including a plurality of cells arranged in series and/or in parallel in a protective casing in order to form a battery or an assembly called a battery pack.

Charging and discharging a battery are exothermic processes. However, in the case of an excessively high temperature, ageing reactions are accelerated and the result may be a reduction in the service life of the battery. There is also a risk of thermal runaway that may go as far as destruction of the battery. On the other hand, in the case of an excessively low temperature, i.e. below a predefined minimum threshold, the capacity of the battery may greatly decrease.

It is therefore important to monitor and ensure thermal management of the battery.

Currently the batteries of electric and hybrid vehicles are cooled by means of active systems of various natures.

It may be a case of circulation of air in natural or forced convection, circulation of glycated water or of oil, or the evaporation of a refrigerating fluid.

When it is a case of oil or air in particular, the fluid may be in direct contact with the cells of the battery. Such cooling is termed direct cooling.

In a variant, the fluid may pass over cooling surfaces, for example through a closed circuit including a cooling loop equipped with cooling plates forming heat exchangers. Such cooling is termed indirect cooling.

In the case of indirect cooling, it is necessary to maximize the contact surfaces between the heat exchangers and the battery and to limit the contact resistances in order to avoid overheating of the cells degrading the service life and performances thereof. In order to minimize the contact resistances, battery manufacturers generally have recourse to the use of thermal interface materials of the film or pad type, or thermal paste.

Fitting these elements is often complex and expensive and may require a great deal of time when the battery pack is assembled.

The invention aims to remedy the aforementioned problems, in a simple, reliable and inexpensive manner.

### SUMMARY OF THE INVENTION

For this purpose, the invention relates to a thermal regulation device including a member to be heated or to be cooled, a fluid-circulation conduit comprising at least one flexible part able to deform according to the pressure of the fluid within the conduit, and at least one contact zone coming into contact with said member when the pressure of the fluid in the conduit is higher than a given pressure and which is moved away from said member when the pressure of the fluid in the conduit is below the given pressure, the thermal regulation device including regulation means able to vary the pressure of the fluid in the conduit.

In this way, it is possible to cool or heat the member when the conduit is in contact with said member. Moreover, it is possible to stop or reduce the cooling or the heating of the member when they contact zone is separated from said member. The movement of the contact zone is obtained by deforming the flexible part, by adapting, during the operation of the thermal regulation device, the pressure of the fluid within the conduit, using regulation means.

These features make it possible in particular:
to limit the thermal inertia in the separated position of the contact zone, so as to facilitate the heating of the member to be heated, for example under winter operating conditions.
to facilitate the mounting or dismantling of such a device by separating the zone from said member, so as to form a mounting clearance.

Returning the contact zone into the separated position can be provided by the intrinsic elasticity of the flexible part, by the addition of additional return means, or by applying a negative pressure in the conduit so as to suck the fluid contained in the conduit, at least partly, and thus to separate the contact zone from the member to be heated or to be cooled.

Applying a negative pressure is particularly useful in the case of mounting or dismantling such a device.

The contact zone may be formed, at least partly, by the flexible part.

The ratio between the contact surface between the conduit and the member to be heated when the pressure of the fluid is below the given pressure, and the contact surface between the conduit and the member to be heated when the pressure of the fluid is above the given pressure, may be between 0 and 1, preferably between 0 and 0.5.

The fluid may be a heat-transfer fluid, for example glycated water, or a refrigerating fluid.

The contact between the conduit and the member may be direct or indirect, i.e. implemented by means of an additional element or of an interface layer.

The flexible part may be produced from elastomer or from thermoplastic or metal material, or by a combination of materials, at least in part.

The elastomer material is for example of the rubber type.

The thermoplastic material is for example of the TPV type.

The elastomer or thermoplastic material may be loaded, at least in one zone of the conduit, by means of a thermally conductive filler, for example graphite, in order to improve the heat exchanges between the fluid and the member.

In a variant, the filler may be a flame-retardant material or an electrical insulator, or a combination of the aforementioned fillers.

At least a part of the conduit may include a composite material, a thermoplastic material or a thermosetting material, or a combination of these materials.

The flexible part may include at least one wall including at least one zone inclined with respect to the direction of the movement of the contact zone.

The contact zone moves for example in translation along an axis perpendicular to the member in the zone intended to come into contact with the conduit. A translation along the axis of the wall in the contact zone could also be envisaged.

Adapting the pressure in the conduit can also make it possible to vary the contact surface between the conduit and the element or elements to be cooled or to be heated. In this case, the higher the pressure in the conduit, the more extensive will be the contact zone, so as to favor the heat exchanges. Conversely, the lower the pressure in the conduit, the smaller will be the contact zone, or even zero, so as to limit the heat exchanges.

Said wall may include a plurality of successive inclined zones, oriented in different directions.

The flexible zone may thus have the general form of a bellows able to deform.

The contact zone may include at least one metal part.

Such a metal part makes it possible to favor the heat exchanges.

Said metal part may be intended to come into contact with the fluid in the conduit and with the member.

In a variant, the metal part may be embedded in the thickness of the conduit.

The device may include a support part, the conduit being formed partly or bearing on said support part, opposite the contact zone.

The support part may be a casing element of an electric battery of an automobile.

The support part may be a crossmember or a longitudinal member. The crossmember or the longitudinal member may be produced from a composite or metal material. The composite material may include reinforcement fibers embedded in a polymer matrix.

The support part may be a material consisting of a set of plies superimposed on one another, the conduit being delimited at least partly between two plies of the support part. Such a support thus incorporates the conduit function. Such a support can be produced by a pultrusion or extrusion method by drawing or gluing or welding.

The device may include a plurality of conduits separated from each other and each including a flexible part and a contact zone able to come into abutment on or to be separated from the member to be heated or to be cooled.

One and the same support part may be common to at least two conduits.

One and the same metal part intended to come into contact with the fluid and with the member may be common to a plurality of conduits.

Said metal part and/or the support part may be a metal sheet.

The device may include at least one elastic member mounted between the contact zone and the support part. In a variant, said elastic member may be mounted between the contact zone and the member to be heated or to be cooled.

Said elastic member may be of the shape memory type. Said elastic member may be housed in the conduit or outside it.

The elastic member may be formed by an element distinct from and separated from the flexible part of the conduit. In a variant, the elastic member may be formed by the flexible part itself, or by an element that is distinct from but incorporated in the flexible part.

The elastic member may be formed by a spring, for example a compression spring or a draw spring. The spring is for example a helical spring.

The device may include means for storing calories and/or frigories.

Said means for storing calories and/or frigories may include a phase-change material or PCM, for example water, glycol, a saline solution or paraffin. In particular, the thermal phase-change material (PCM) may consist of n-hexadecane, eicosane or a lithium salt, all having melting points below 50° C. As an alternative, the PCM material may be based on fatty acid or eutectic or hydrated salt, or fatty alcohols, for example. Such thermal storage means make it possible to accumulate thermal energy (calories or frigories) by latent heat (phase change) or by sensible heat.

These storage means may in particular be charged with calories or frigories during a first operating phase, or be discharged either by heating or by cooling the member, or through the fluid circulating in the conduits, in a second operating phase.

Said means for storing calories and/or frigories may be mounted in a conduit of the device or between two conduits of the device.

The conduit may include a reinforcement extending over all or part of the conduit. Said reinforcement may include reinforcement fibers embedded in or on the surface of a polymer matrix. The matrix is intended to fulfil the function of fluid tightness.

The thermal regulation device may include heating means able to heat said member and/or the fluid circulating in the conduit.

The heating means may be incorporated in the conduit.

The heating means may include metal or carbon fibers, coming for example from the reinforcement, able to form an electrical resistance capable of generating calories by Joule effect when a voltage is applied to said fibers or to said armoring.

Some of the reinforcement fibers may then fulfil both the function of reinforcement and the function of thermal heating.

The heating means may include a metal or carbon armoring able to form an electrical resistance capable of generating calories by Joule effect when a voltage is applied to said fibers or to said armoring.

The armoring may also fulfil the reinforcement function in addition to the heating function.

The reinforcement may be produced by means of a non-woven or woven structure.

The reinforcement may be obtained by braiding, knitting, yarn-covering or spiral winding of metal or carbon-based threads or fibers. The reinforcement threads or fibers may have a resistivity of between 10¹² and 10⁶ Ω·cm.

The reinforcement structure may be able to afford a flexibility of the conduit by a suitable arrangement of the threads or fibers.

The fluid-circulation conduit may be in the general form of a tube.

The fluid-circulation conduit may be in the general form of a pouch. The pouch may include a fluid inlet and a fluid outlet. The inlets and outlets of the pouch may be located at the same end of the pouch or respectively at two opposite ends of the pouch.

The pouch may include a wall with an annular cross-section, having a constant thickness over the entire periphery. Such a pouch may be produced by extrusion for example. Such a pouch does not have any covering of material over its thickness.

In a variant, the pouch may include a wall with an annular cross-section, having a covering zone wherein two wall thicknesses are sealingly attached to each other.

The pouch may be partly formed by the support part, for example a longitudinal member or a crossmember, or partly by a wall sealingly attached to the support part, so as to delimit an internal volume of the pouch with the support part.

The thermal regulation device may include at least one first movable plate able to come into abutment on the member to be heated or to be cooled, at least one second movable plate fixed with respect to the first movable plate, and at least one intermediate plate mounted between said movable plates, the first movable plate and the intermediate plate delimiting the conduit, the intermediate plate including at least one flexible protrusion forming the flexible part and able to deform according to the pressure of the fluid in the conduit, said protrusion extending through at least one opening in the second movable plate and being able to bear on a support part.

In operation, when the internal volume of the conduit is not supplied with pressurized fluid, the protrusion is not deformed and occupies a minimum volume so that the movable plates are separated from the member to be heated or to be cooled and are close to the support part.

Conversely, when the internal volume of the conduit is supplied with pressurized fluid, the protrusions are deformed or inflated by the pressurized fluid. This has the effect of increasing the dimension of said protrusions in the direction perpendicular to the plates, i.e. to increase the distance between the movable plates and the support part. This also has the effect of reducing the distance between the member to be heated or to be cooled and the first movable plate, until said first movable plate comes into contact with said member, so as to allow an exchange of heat between the fluid flowing or present in the conduit and said member.

The conduit may be in the general form of a pouch.

The inlet and the outlet may be located in two zones of the pouch separated from each other, for example at two ends of the pouch.

At least some of the conduits may be connected by fluidic-connection zones so as to form one or more channels in the general form of a coil or of chicanes extending from one conduit to the other. The conduits may be located at the same face of the member to be heated or to be cooled. The conduits may be connected “in series” one after the other, in “parallel”, or any combination of the two modes, by means of the connection zones.

At least one internal channel in the general form of a coil or including any type of chicane may be formed in at least one pouch of the aforementioned type.

The pouch may be formed by a first part forming in particular a first longitudinal face and a second part forming in particular a second longitudinal face, the two parts being assembled sealingly on one another. The longitudinal direction can be defined as the extension direction or the largest-dimension direction of the pouch.

The inlet and the outlet may be located at longitudinal faces of the pouch and may extend perpendicularly to the median general plane of the pouch. The inlet and the outlet may be located at opposite longitudinal ends of the pouch i.e. opposite to each other.

The inlet and the outlet may be located at the same longitudinal face of the pouch.

The inlet and the outlet may be located at the same longitudinal end of the pouch.

The inlet and the outlet may be located at two opposite longitudinal ends of the pouch.

The channel or channels may include a narrowing of its cross-section, gradual or not, for example from the inlet towards the outlet.

At least one conduit or at least one pouch may be provided with means for generating turbulence in the fluid flow passing through the conduits. These turbulence-generating means offer example formed by zones of material or corrugations, for example in the form of a chevron. It is also possible to form these turbulence-generating means by means of inserts. These means may be formed or molded on the walls or the faces of the conduit or of the pouch, or be formed by distinct pieces secured to said walls or faces of the conduit or of the pouch. These means may also be formed on a surface against which the conduit or the pouch comes to be pressed when the conduit or the pouch is subjected to a pressurized fluid, for example a face of the cells or of the support. The member to be heated or to be cooled may be one or more battery cells, for example for an automobile.

Each cell may have a roughly parallelepipedal form having first lateral faces and second lateral faces, the first faces having a larger dimension than the second faces. The conduits may extend along the first faces and/or the second faces.

Each cell may have a cylindrical shape. The cells may be arranged in a zigzag. The conduits may extend between the cells and have curved zones following the cylindrical shapes of the cells, at least in part.

The cells may be so-called pouch cells including a pouch made from aluminized multilayer film, or made from aluminum or from plastics material for example.

The cells, for example cylindrical, pouch or prismatic, can be housed in a support block made from thermally conductive material, at least one conduit being able to come into contact with at least one lateral face of said support block.

The device may include means for measuring and/or calculating the temperature of the cells, and regulation and/or control means for adapting the pressure of the fluid flowing in the conduits accordingly. The latter may also adapt the temperature of the fluid accordingly.

The device may include means for circulating the fluid in the conduits.

The invention also relates to an automobile, for example of the electric or hybrid type, characterized in that it includes at least one device of the aforementioned type.

### BRIEF DESCRIPTION OF THE FIGURES

FIG. 1 is an exploded view, in perspective, of a part of a thermal regulation device according to a first embodiment of the invention,

FIG. 2 is a side view of a part of the device, in a first position of the conduits,

FIG. 3 is a detail view of FIG. 2,

FIG. 4 is a view corresponding to FIG. 3, illustrating a second position of the conduits,

FIG. 5 is an exploded view in perspective of a part of the device according to a second embodiment of the invention,

FIG. 6 is a perspective view of a part of the device of FIG. 5,

FIG. 7 is a perspective view of a conduit according to a third embodiment of the invention,

FIG. 8 is a perspective view of a part of the device according to a fourth third embodiment of the invention,

FIG. 9 is a perspective view of a part of the device according to a fifth embodiment of the invention,

FIG. 10 is a view corresponding to FIG. 9, illustrating a sixth embodiment of the invention,

FIG. 11 is a view corresponding to FIG. 9, illustrating a seventh embodiment of the invention,

FIG. 12 is a view illustrating the mounting of conduits at one of the largest lateral faces of a battery cell parallelepipedal in shape, in accordance with an eighth embodiment of the invention,

FIG. 13 is a view illustrating the mounting of conduits at the smallest lateral faces of adjacent parallelepipedal cells, in accordance with a ninth embodiment of the invention,

FIG. 14 is a perspective view, illustrating a part of a device according to a tenth embodiment,

FIG. 15 is a perspective view, illustrating a part of a device according to an eleventh embodiment,

FIG. 16 is a perspective view, illustrating a part of a device according to a twelfth embodiment,

FIG. 17 is a perspective view of a pouch of FIG. 16,

FIG. 18 is a perspective view of a pouch according to a thirteenth embodiment of the invention,

FIG. 19 is a perspective view of a pouch according to a fourteenth embodiment of the invention,

FIG. 20 is a perspective view of a pouch according to a fifteenth embodiment of the invention,

FIG. 21 is a perspective view of a pouch according to a sixteenth embodiment of the invention,

FIG. 22 is a perspective view of a pouch according to a seventeenth embodiment of the invention,

FIG. 23 is a perspective view, illustrating a part of a device according to an eighteenth embodiment,

FIG. 24 is a perspective view, illustrating a part of a device according to a nineteenth embodiment,

FIG. 25 is a perspective view of a plurality of conduits according to a twentieth embodiment,

FIG. 26 is an exploded perspective view of a pouch according to a twenty first embodiment of the invention,

FIG. 27 is a view corresponding to FIG. 26, illustrating a pouch according to a twenty second embodiment,

FIG. 28 is a view corresponding to FIG. 26, illustrating a pouch according to a twenty third embodiment,

FIG. 29 is a view corresponding to FIG. 26, illustrating a pouch according to a twenty fourth embodiment,

FIG. 30 is a view corresponding to FIG. 25, illustrating conduits according to a twenty fifth embodiment,

FIG. 31 is a detail view of a part of FIG. 30.

### DETAILED DESCRIPTION OF THE INVENTION

FIGS. 1 to 4 illustrate a thermal regulation device 1 according to a first embodiment of the invention. This includes a member to be heated or to be cooled, formed here by a set of battery cells 2 of an automobile. The cells 2 are parallelepipedal in shape and adjacent to each other.

The device includes fluid-circulation conduits 3 separated from each other and extending for example along the lateral walls with the smallest surface area 2a of the cells 2.

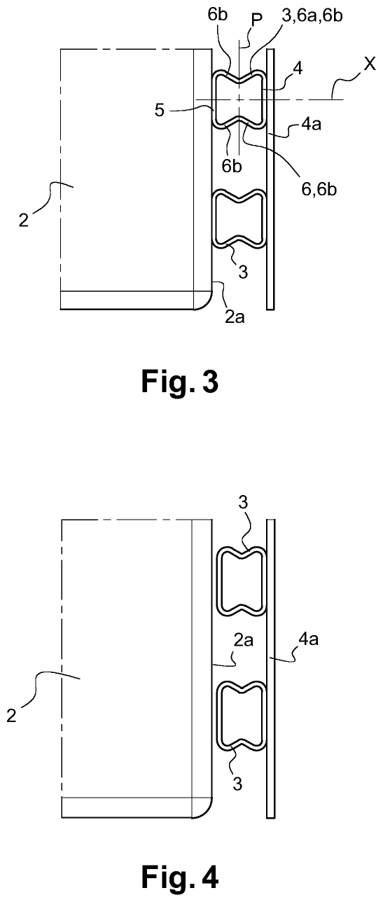

As can be seen in FIG. 3 in particular, each conduit 3 includes, in cross-section, a first end 4 in contact with a support 4a, represented here by a fixed plate, a second end 5 intended to come into contact with the cells 2 and opposite to the first end 4, and a middle zone 6. The ends 4, 5 are substantially planar.

The first ends 4 of the conduits 3 can be attached to the support 4a by gluing or welding or by riveting for example. In a variant, the support 4a can form the ends 4 of the conduits 3.

The middle zone 6 is flexible and deformable along an axis denoted X. The middle zone 6 is in the general form of a bellows. In particular, the middle zone 6 is formed by two lateral walls 6a of the conduit 3 each including zones 6b inclined with respect to the axis X, here two inclined zones 6b arranged symmetrically with respect to a mid-plane P located between the planes of the ends 4, 5 and parallel to said planes of the ends 4, 5.

A fluid, for example a heat-transfer fluid or a refrigerating fluid, circulates in the conduits 3.

Each conduit 3 is here formed in a single piece, for example made from elastomer material.

The elastomer material is for example of the TPV type. The elastomer material may be loaded, at least in one zone of the conduit 3, by means of a thermally conductive filler, for example graphite, in order to improve the heat exchanges between the fluid and the cells. The conduits 3 may alternatively be formed from metal or composite materials or multilayer film, or an association of a plurality of materials.

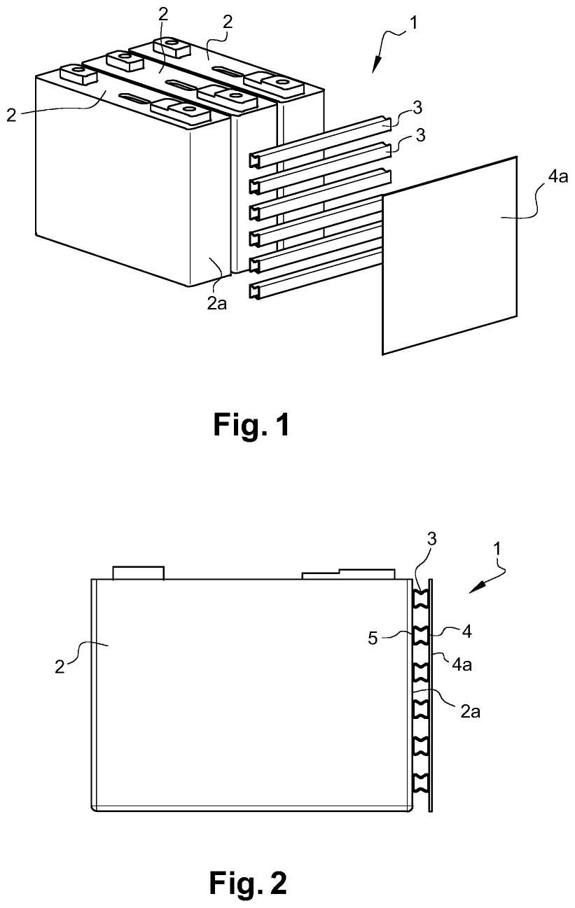

The middle zone 6 is able to deform according to the pressure of the fluid in the conduit 3, between a first position illustrated in FIGS. 2 and 3 and a second position illustrated in FIG. 4.

In the first position (FIGS. 2 and 3), the pressure of the fluid in the conduit 3 is higher than a threshold value. In this position, the first end 5 is in contact, in particular in direct contact, with the cells 2 of the battery, so as to allow an exchange of heat between the fluid flowing in the conduits 3 and the cells 2.

In the second position (FIG. 4), the pressure of the fluid in the conduit 3 is below the threshold value. In this position, the first end 4 is separated from the cells 2 of the battery, so as to avoid or limit the exchanges of heat between the fluid flowing in the conduits 3 and the cells 2. Return to the second position can be provided by the elasticity of the middle zone 6.

The device 1 may include means for measuring and/or calculating the temperature of the cells 2, and regulation and/or control means for adapting the pressure of the fluid flowing in the conduits 3 accordingly. The latter may also adapt the temperature of the fluid accordingly.

The first position may for example make it possible to provide the cooling of the cells 2 as needed. The second position may for example make it possible to avoid such cooling, in particular when they need to be heated, for example under winter conditions.

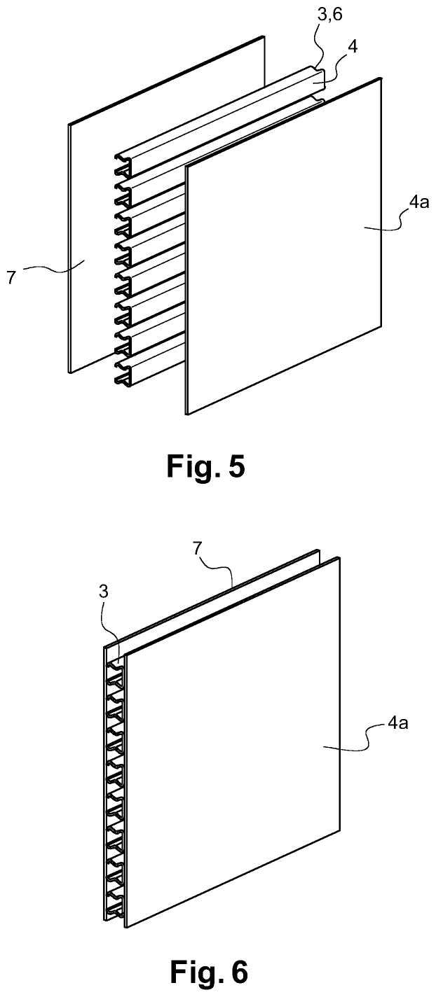

FIGS. 5 and 6 illustrate a second embodiment of the invention, which differs from the one disclosed with reference to FIGS. 1 to 4 in that each conduit 3 is formed by two distinct parts, namely a first part forming the first end 4 and the middle zone 6, and a second part formed by a zone of a metal sheet 7, for example made from aluminum, or a panel produced from thermally conductive material. The junction between the first part 4, 6, produced for example from elastomer, and the metal sheet 7, is a fluidtight junction so that the fluid can flow in the internal volume of the conduit 3 delimited by the first end 4, the middle zone 6 and the relevant zone of the sheet 7. The fluid is in direct contact with the sheet 7.

In this embodiment, the same sheet 7 is common to several conduits 3.

The sheet 7 is thus able to move in translation with respect to the first end 4, between a first position in which it is able to come into abutment against the cells 2 of the battery, and a second position in which it is separated from said cells 2.

Such an embodiment improves the conductivity of the contact zone between the conduits 3 and the cells 2.

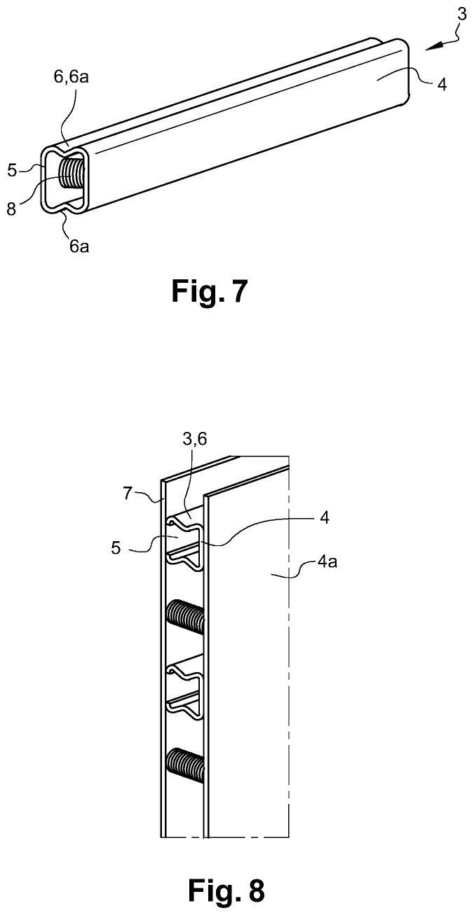

FIG. 7 illustrates a third embodiment of the invention, which differs from the one described with reference to FIGS. 5 and 6 in that the elastic members 8, here helical draw springs, are mounted in the conduits 3. A first end of each elastic member 8 is attached to the first end 4 of the conduit 3, a second end of each elastic member 8 being attached to the second end 5 of the conduit 3. The elastic members 8 exert a return force tending to bring together the first and second ends 4, 5 of each conduit 3. In other words, the elastic members 8 tend to return the conduits 3 towards the position illustrated in FIG. 4.

FIG. 8 illustrates a fourth embodiment of the invention, which differs from the one described with reference to FIG. 7 in that the elastic members 8, here also formed by helical draw springs, are mounted between the support 4a and a metal sheet 7 similar to the one described with reference to FIGS. 5 and 6, i.e. a sheet 7 forming the second ends 5 of the conduits 3.

The elastic members 8 exert a return force tending to bring together the support 4a and the sheet 7.

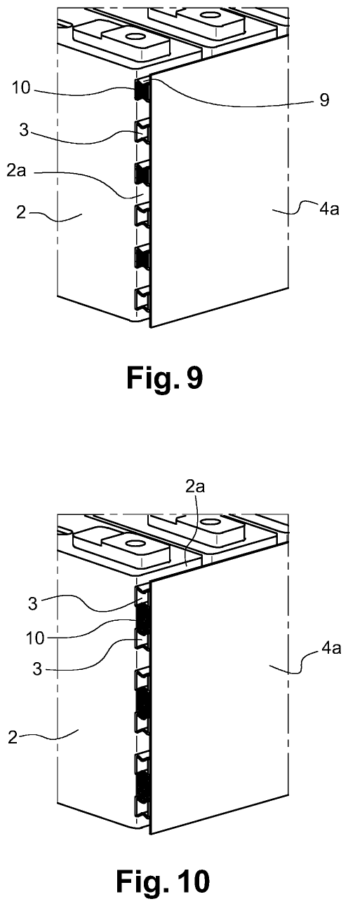

FIG. 9 illustrates a fifth embodiment of the invention, which differs from the one described with reference to FIGS. 1 to 4 in that the device 1 includes conduits 9 filled, at least partially, with a phase-change material 10. These conduits 9 are not intended for the circulation of a fluid and do not necessarily include a deformable zone 6. In particular, the second ends 5 of the conduits 3 filled with such a material can be maintained in contact with the cells 2 of the battery.

The number of conduits 9 filled with phase-change material may be variable, as well as the distribution thereof in the conduits 3 in which the fluid circulates.

The phase-change material 10 or PCM is for example water, glycol, a saline solution or paraffin. In particular, the phase-change material 10 may consist of n-hexadecane, eicosane or a lithium salt, all having melting points below 50° C. As an alternative, the phase-change material 10 may be based on fatty acid or eutectic or hydrated salt, or fatty alcohols, for example. Such a material is a thermal storage means making it possible to accumulate thermal energy (calories or frigories) by latent heat (phase change) or by sensible heat.

Such a material 10 may in particular be charged with calories or frigories during a first operating phase, or be discharged either by heating or by cooling the cells 2, or through the fluid circulating in the conduits 3, in a second operating phase.

The conduits 3 in which the fluid flows can serve for cooling the cells 2 and the phase-change material 10 can make it possible to store the calories when the thermal dissipation of the cells 2 is too great.

FIG. 10 illustrates a sixth embodiment, which differs from the one described with reference to FIGS. 1 to 4 in that the device 1 includes phase-change material 10 of the aforementioned type, in the spaces located between the conduits 3, the support 4a and the cells 2.

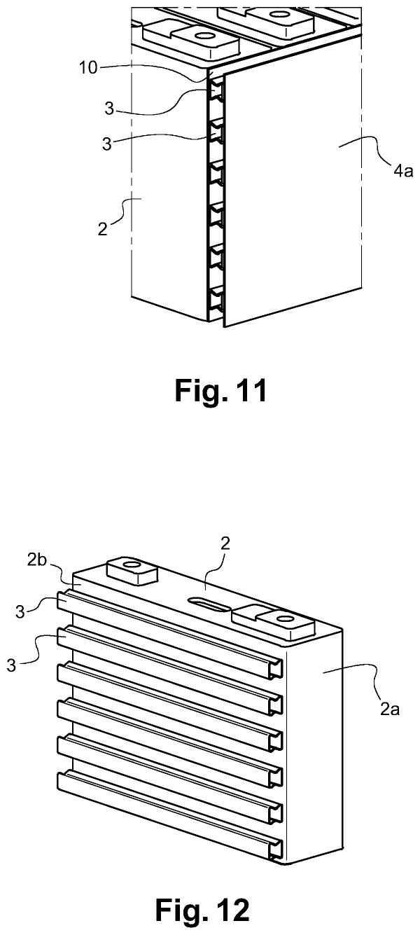

FIG. 11 illustrates a seventh embodiment, which differs from the one described with reference to FIGS. 1 to 4 in that the device 1 includes a layer of phase-change material 10 of the aforementioned type, located between the second ends 5 of the conduits 3 and the cells 2. In such an embodiment, the conduits 3 can be used for discharging the calories stored in the phase-change material for example.

FIG. 12 illustrates an eighth embodiment in which the conduits 3 extend along at least one lateral wall with the largest surface area of a cell 2.

Conversely, FIG. 13 illustrates a ninth embodiment, similar to the one described previously, the conduits 3 extending along lateral walls with the smallest surface area of the cells 2. The cells 2 are placed adjacent to one another, at their largest lateral walls.

Naturally, it is possible to combine the use of conduits 3 both along the smallest lateral walls and along the largest lateral walls.

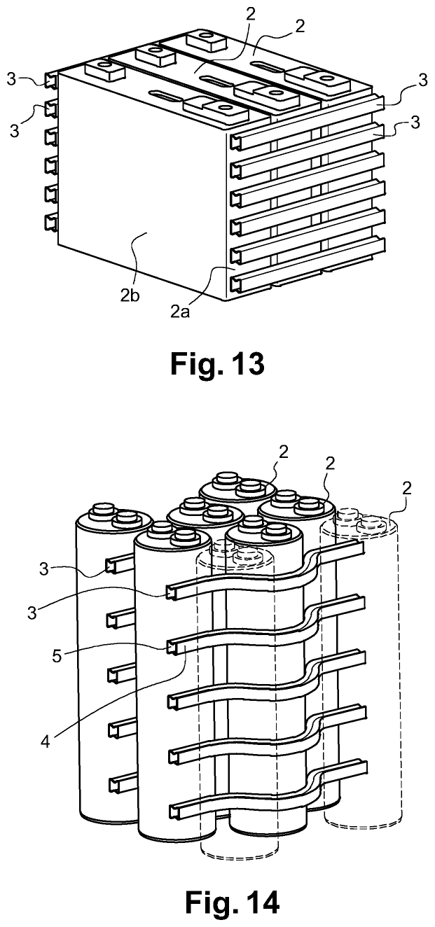

FIG. 14 illustrates a tenth embodiment in which the cells 2 each have a cylindrical shape, the cells 2 being parallel to one another and arranged in a zigzag. The conduits 3 extend between the cells 2 and have curved zones following the cylindrical shapes of the cells 2, at least in part.

Each conduit extends for example in a plane perpendicular to the axes of the cells 2.

The first ends 4 of the conduits 3 may be secured to certain cells 2, which then serve as a fixed support, and the second ends 5 of the conduits 3 can be able to come into abutment on the opposite cells 2, according to the pressure of the fluid inside the conduits 3.

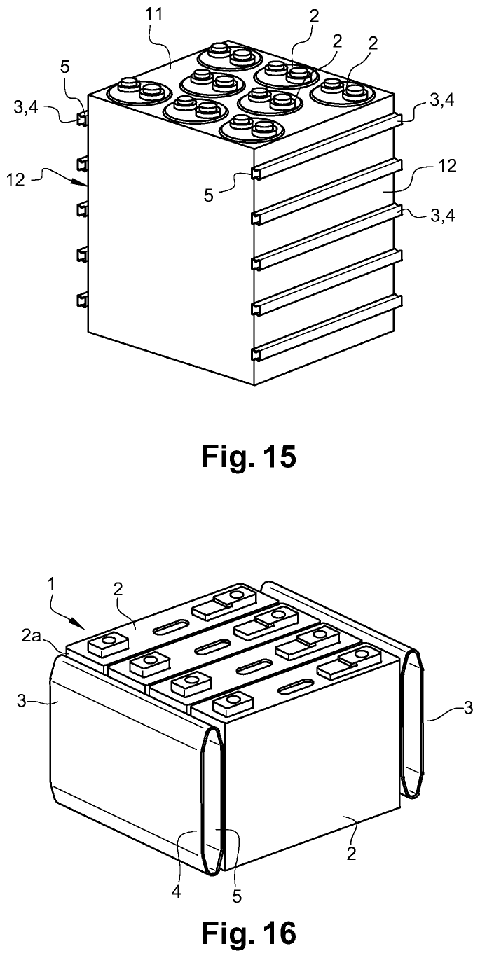

FIG. 15 illustrates an eleventh embodiment in which the cells 2 are for example cylindrical and are housed in a block 11 of thermally conductive material, the conduits 3 being arranged along at least one lateral face 12 of said support block. As previously, the first ends 4 of the conduits 3 may be secured to a support, not shown in FIG. 14, the second ends 5 of the conduits 3 being able to come into abutment on the corresponding natural face 12 of the block 11 according to the pressure of the fluid inside the conduits 3.

FIG. 16 illustrates a twelfth embodiment, which differs from the embodiment illustrated in FIG. 13 in that the conduits 3 are formed by pouches 3 extending for example over the entire height of the cells 2 and extending along the lateral faces with the smallest dimensions 2a of the cells 2.

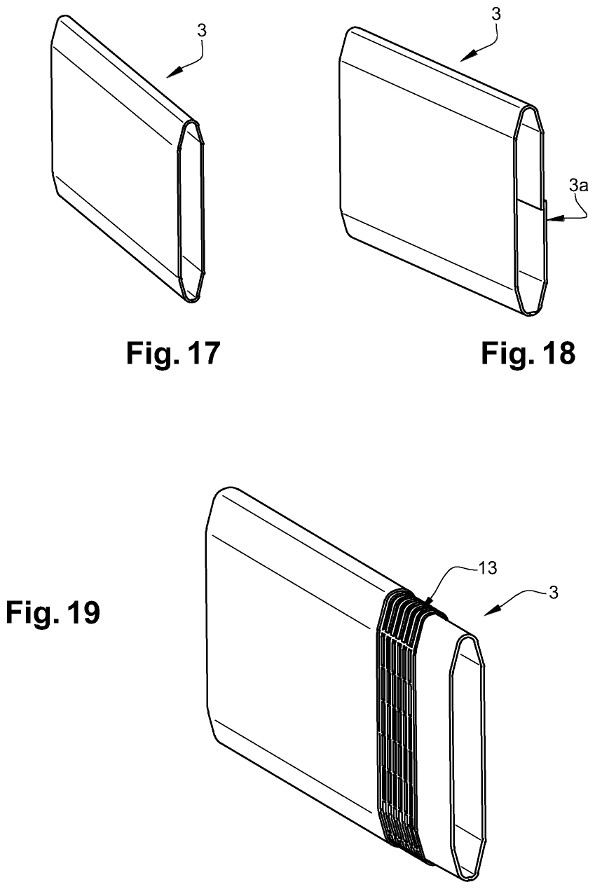

As is more clearly visible in FIG. 17, each pouch 3 may include a wall with an annular cross-section, having a constant thickness over the entire periphery. Such a pouch 3 may be produced by extrusion for example. Such a pouch does not have any covering of material over its thickness.

According to a variant illustrated in FIG. 18, each pouch 3 may include a wall with an annular cross-section, having a covering zone 3a wherein two wall thicknesses are sealingly attached to each other, for example by welding or gluing.

FIG. 19 illustrates a fourteenth embodiment in which the pouch 3, or more generally the conduit, includes a reinforcement 13 extending over all or part of the conduit 3. The reinforcement 13 is formed by a metal or carbon armoring able to form also an electrical resistance capable of generating calories by Joule effect when a voltage is applied to said armoring. The pouch or conduit 3 thus includes heating means that can be used or not according to the operating conditions. The armoring or reinforcement 13 is able to allow flexibility of the pouch or conduit 3.

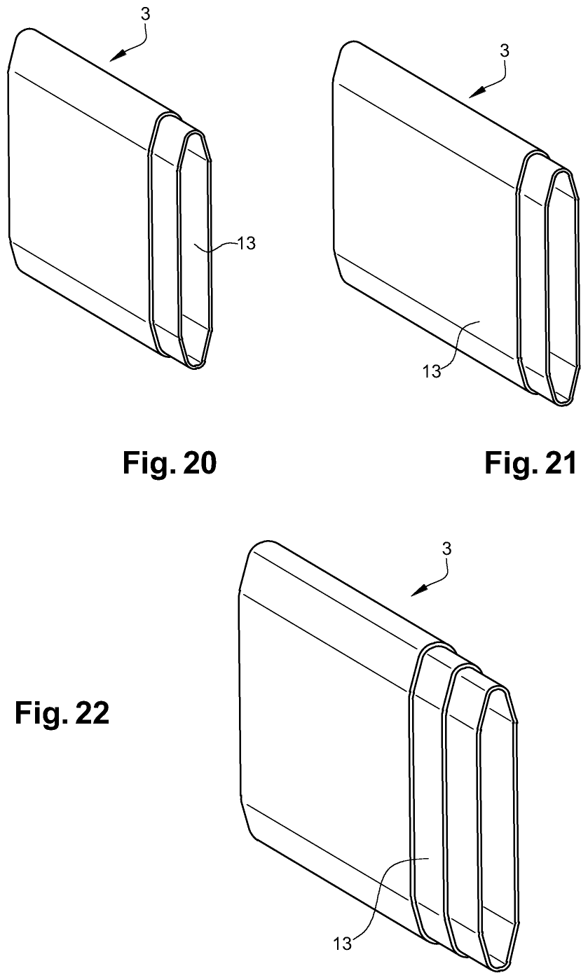

FIG. 20 illustrates a fifteenth embodiment in which the pouch 3 is equipped with a reinforcement 13 in the form of a metal blade with an annular cross-section, said reinforcement 13 being sufficiently flexible to allow the deformation of the pouch 3.

In this embodiment, the reinforcement 13 is located at the internal face of the pouch 13.

FIG. 21 illustrates a sixteenth embodiment, which differs from the one described with reference to FIG. 20 in that the reinforcement 13 is located at the internal face of the pouch 3.

FIG. 22 illustrates a seventeenth embodiment, which differs from the one described with reference to FIG. 20 in that the reinforcement 13 is incorporated in the thickness of the pouch 3.

Such a metal reinforcement 13 can also make it possible to favor the heat exchanges between the cells 2 and the fluid circulating in the pouch 3.

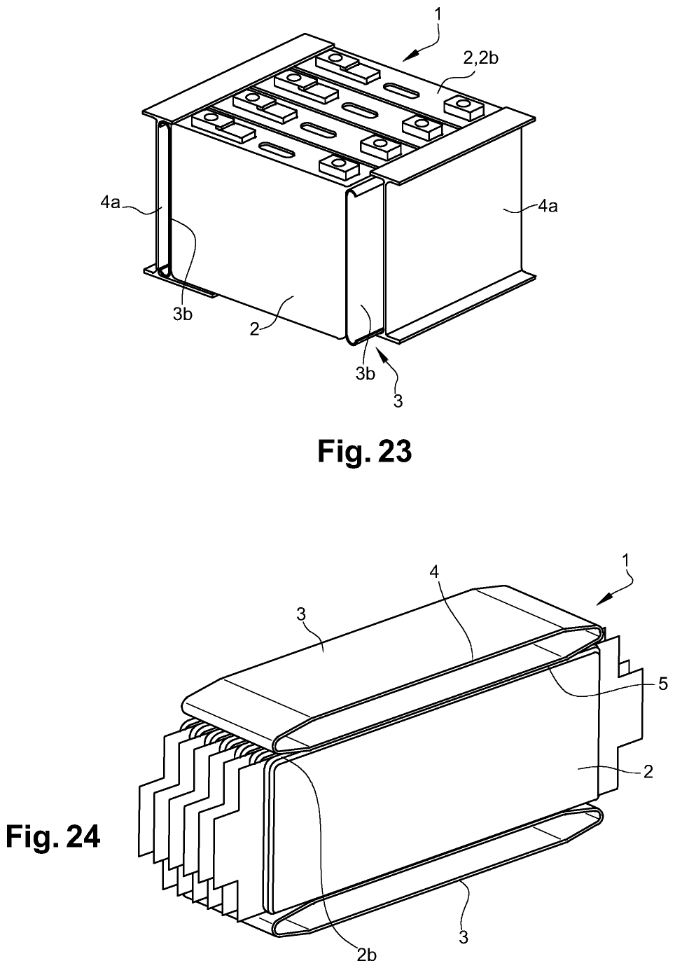

FIG. 23 illustrates an eighteenth in which the support parts 4a are formed by crossmembers. Each crossmember 4a may be produced from a composite or metal material. Each crossmember may have a cross section in a roughly I, U or L form. The composite material may include reinforcement fibers embedded in a polymer matrix.

Each pouch 3 is partly formed by the support part 4a, and partly by a wall or a flexible sheet 3b sealingly secured to the support part 4a at the bottom and top edges thereof, so as to delimit an internal volume of the pouch 3 with the support part 4a.

FIG. 24 illustrates a nineteenth embodiment, which differs from the one described with reference to FIG. 16 in that the pouches 3 extend along the lateral walls with the largest surface area 2b of the cells 2.

The cells 2 may be so-called pouch cells each including a pouch made from aluminum or plastics material for example.

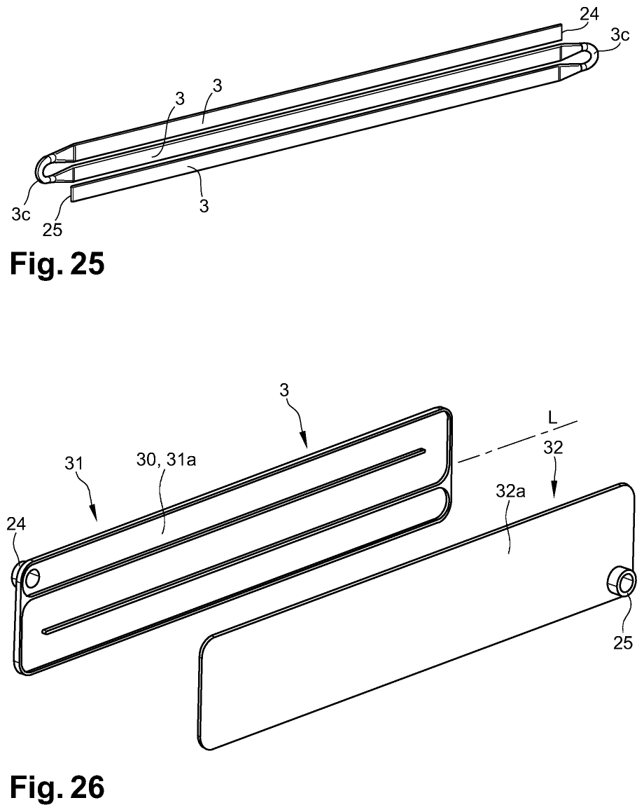

FIG. 25 illustrates another embodiment, which differs from those disclosed with reference to FIGS. 1 to 15 in that at least some of the conduits 3 are connected by fluidic-connection zones 3c so as to form a channel in the general form of a coil or of chicanes extending from one conduit to the other. The channel includes an inlet 24 and an outlet 25. The conduits 3 are located at the same face of the cell or cells 2a and can thus all be connected “in series” one after the other, by means of the connection zones 3c.

FIG. 26 illustrates another embodiment in which the device includes at least one pouch 3 similar for example to the pouch in FIG. 17, but in which an internal channel 30 in the general form of a coil is formed. The coil form is one example among other forms that the fluid circulation inside the pouch 3 could take.

The pouch 3 is for example formed by a first part 31 forming in particular a first longitudinal face 31a and a second part 32 forming in particular a second longitudinal face 32a, the two parts 31, 32 being assembled sealingly on one another. The longitudinal direction L is here defined as the extension direction or the largest-dimension direction of the pouch 3.

In this embodiment, the inlet 24 and the outlet 35 are located at longitudinal faces 31a, 32a of the pouch 3 and extend perpendicularly to the median general plane of the pouch 3. The inlet 24 and the outlet 25 are here located at opposite longitudinal ends of the pouch 3, i.e. opposite to each other.

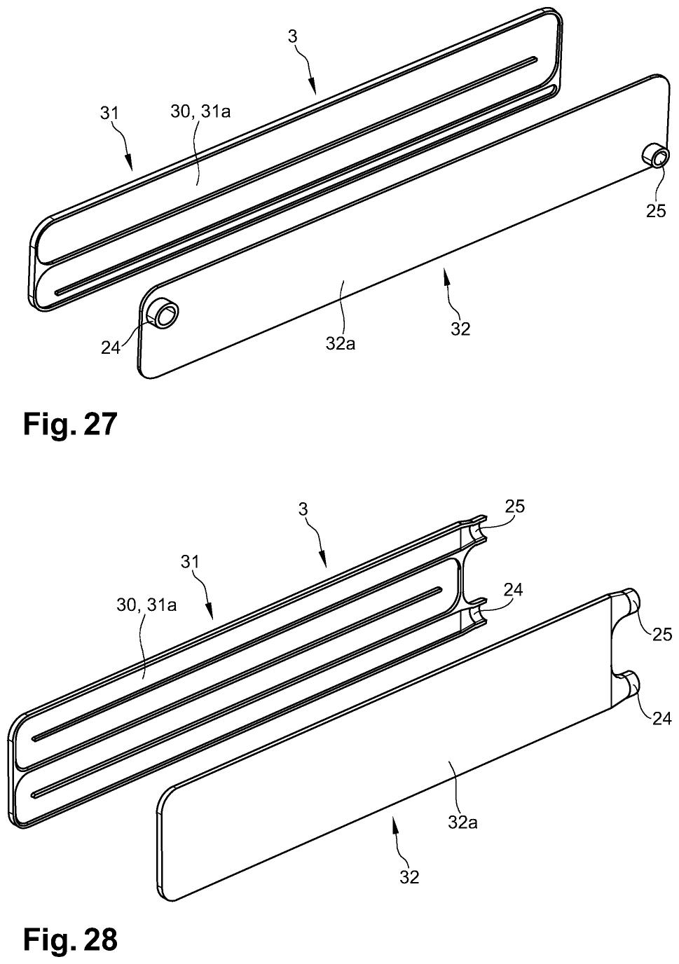

FIG. 27 illustrates another embodiment, which differs from the one described with reference to FIG. 26 in that the inlet 24 and the outlet 25 are located at the same longitudinal face of the pouch.

Moreover, the channel may include a narrowing of its cross-section, gradual or not, for example from the inlet towards the outlet, as illustrated on this figure. Such a narrowing is also applicable to the other embodiments.

FIG. 28 illustrates another embodiment, which differs from the one described with reference to FIG. 26 in that the inlet 24 and the outlet 25 are located at the same longitudinal end of the pouch 3.

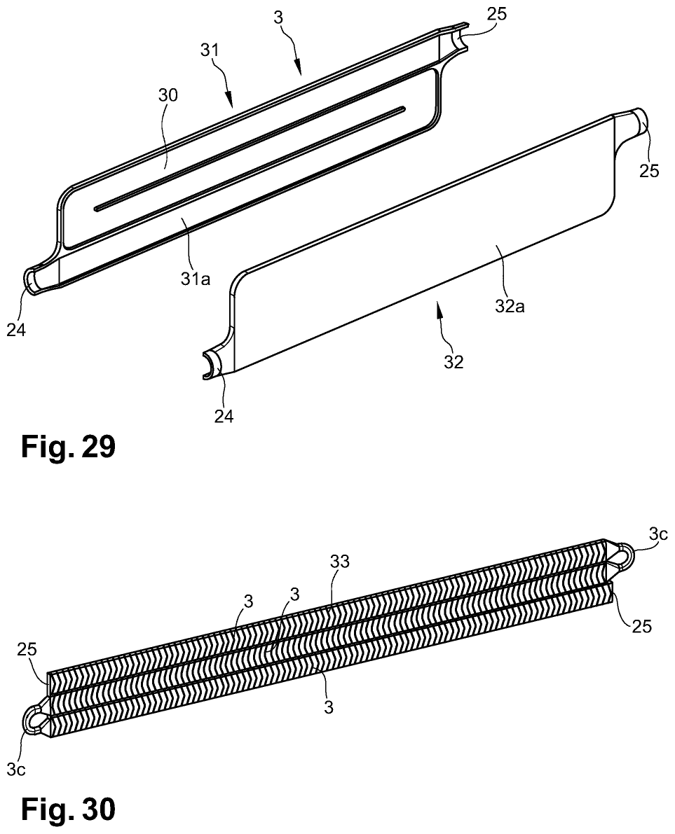

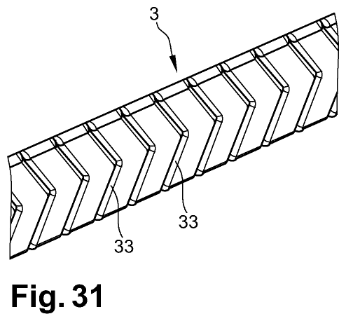

FIG. 29 illustrates another embodiment, which differs from the one described with reference to FIG. 27 in that the inlet 24 and the outlet 25 are located at two opposite longitudinal ends of the pouch 3.

FIG. 30 illustrates another embodiment, which differs from the one described with reference to FIG. 25 in that at least one conduit 3 is provided with means for generating turbulence in the flow of fluid passing through the conduits 3. These turbulence-generating means are for example formed by zones of material or corrugations 33, for example in the form of a chevron.

It is also possible to form these turbulence-generating means by means of inserts distinct from the conduits 3 and secured to or inserted in the relevant conduit 3. These means may be formed or molded on the walls or the faces 31a, 32a of the conduit 3, or be formed by distinct pieces secured to said walls or faces 31a, 32a of the conduit 3. These means may also be formed on a surface against which the conduit 3 comes to be pressed when the conduit is subjected to a pressurized fluid, for example a face of the cells 2a or of the support 4a. Naturally, such turbulence-generating means may be applied to the embodiments including a pouch.

1. A thermal regulation device (1) for a member (2) to be heated or to be cooled comprises:
a fluid-circulation conduit (3) comprising at least one flexible part (6) able to deform according to the pressure of the fluid within the conduit (3), and at least one contact zone (5) coming into contact with said member (2) when the pressure of the fluid in the conduit (3) is higher than a given pressure and which is moved away from said member (2) when the pressure of the fluid in the conduit (3) is below the given pressure, and
regulation means able to vary the pressure of the fluid in the conduit (3).

2. The device according to claim 1, characterized in that the flexible part (6) is produced from elastomer or thermoplastic material or from metal or from multilayer film, at least in part.

3. The device according to claim 2, characterized in that the flexible part (6) includes at least one wall (6a) including at least one zone (6b) inclined with respect to the direction of the movement of the contact zone (5).

4. The device according to claim 1, characterized in that the contact zone (5) includes at least one metal part or any material with high thermal conductivity (7).

5. The device according to claim 1, further comprising a support part (4a), the conduit (3) being formed partly by, or bearing on, said support part (4a), opposite the contact zone (5).

6. The device according to claim 1, characterized in that it includes a plurality of conduits (3) separated from each other and each including a flexible part (6) and a contact zone (5) able to come into abutment against, or to be separated from, the member (2) to be heated or to be cooled.

7. The device according to claim 5, characterized in that it includes an elastic member (8) mounted between the contact zone (5) and the support part (4, 4a).

8. The device according to claim 1, characterized in that it includes a phase-change material (10).

9. The device according to claim 8, characterized in that said phase-change material is mounted between two conduits (3) of the device (1).

10. An automobile, characterized in that it includes at least one device (1) according to claim 1.

11. The device according to claim 8, further comprising a non-fluid-circulation conduit (9).

12. The device according to claim 11, characterized in that the non-fluid-circulation conduit (9) is filled with said phase-change material.
